(19) United States
(12) Patent Application Publication
(10) Pub. No.: US 2008/0218073 A1
(43) Pub. Date: Sep. 11, 2008

(54) Electroluminescent Nixels and Elements with Single-Sided Electrical Contacts

(76) Inventors: Adrian Kitai, Mississauga (CA); Deven J. Anthony, Tampa, FL (US)

Correspondence Address: SUTHERLAND ASBILL & BRENNAN LLP, 999 PEACHTREE STREET, N.E., ATLANTA, GA, 30309, US

(21) Appl. No.: 11/683,489

(22) Filed: Mar. 8, 2007

(51) Int. Cl. H01J 1/62; H01J 9/00

(52) U.S. Cl. 313/509; 445/24

(57) ABSTRACT

Systems and methods are provided for electroluminescent display elements. These electroluminescent display elements can include a dielectric layer having an upper surface and a lower surface and a top conductive layer having an upper surface and a lower surface, where the top conductive layer and the dielectric layer are positioned opposite one another so that the lower surface of the top conductive layer faces the upper surface of the dielectric layer. The electroluminescent display elements can further include a phosphor layer, where the phosphor layer is arranged between the dielectric layer and the top conductive layer, and a bottom conductive layer having an upper surface and a lower surface, where the bottom conductive layer and the dielectric layer are positioned opposite one another so that the upper surface of the bottom conductive layer faces the lower surface of the dielectric layer, and where the bottom conductive layer forms a first bottom electrode and a second bottom electrode.

### FIELD OF INVENTION

This invention relates generally to electroluminescent (EL) displays, and more particularly, to displays composed of individually produced EL elements or nixels each having electrical contacts on the same side of the EL element or nixels.

### BACKGROUND OF INVENTION

Electroluminescence (EL), a well-known phenomenon commonly exploited in flat panel displays, is the conversion of electrical energy to light via the application of an electrical field to a phosphor. Commonly used EL devices include Light Emitting Diodes (LEDs), laser diodes, and EL displays (ELDs). Typically, an ELD is in the form of a thin film electroluminescent (TEEL) device, which is a solid-state device generally comprising a phosphor layer positioned between two dielectric layers, and further including an electrode layer on the surface of each dielectric layer to form a five-layer structure, where the electrode layers define the outer layers and the phosphor layer defines the inner middle layer.

Co-pending U.S. application Ser. No. 11/526,661, filed Sep. 26, 2006, and entitled “Electroluminescent Apparatus and Display Incorporating Same,” which is incorporated herein in its entirety by reference, discloses electroluminescent (EL) nixels (pixel devices) that are individually produced such that EL displays may be produced by assembling as many of the individual nixels as required. The electroluminescent (EL) nixels generally include a laminate of a rear electrode, a first dielectric layer, an EL phosphor layer, a second dielectric layer, and a front electrode. At least one of these two electrodes needs to be transparent for light to escape the display device.

In each of the above-described structures, electrical connections to these EL nixels must be made between the front electrodes and the rear electrodes. However, in some applications, electrical connections to the front (emissive) electrodes are difficult to make because such electrical connections interfere with EL emission from the front electrodes. Further, the front electrode electrical connections require yet another processing step that may introduce additional errors during production.

### SUMMARY OF INVENTION

The systems and methods of the present invention produce an individually sized and shaped modular EL element or chip. According to an embodiment of the invention, these EL elements may be “nixels” as illustratively described herein, which are individually sized and modular shaped EL elements that are adapted to form part of an integrated ELD having multiple electrical contacts on the same side of the EL element structure. Alternatively, the EL elements may be sphere-supported thin film phosphor electroluminescent (SSTFEL) devices, as described in WO 2005/024951 A1, published Mar. 17, 2005, and entitled “Sphere-Supported Thin Film Phosphor Electroluminescent Devices.” While the systems, methods, and apparatuses below for single-sided electrical contacts may be disclosed in the context of nixels, they are for illustrative purposes only. Indeed, it will be appreciated that these systems, methods, and apparatuses for single-sided electrical contacts may also apply to SSTFEL devices or other EL elements as well.

More particularly the present invention provides an EL element or nixel structure that makes use of two rear or substantially same-sided electrodes that are electrically separated by a small gap or other non-conductive (e.g., insulating) material, but that generally cover the rear area of the EL element or nixel laminate. These two electrodes may generally be equal in area and each cover approximately half the EL element or nixel area, according to an embodiment of the invention.

An individual EL element or nixel of the present invention may be manufactured independently of other EL elements or nixels prior to being integrated into an ELD unit, and can be tested and sorted according to predetermined performance characteristics. An EL element or nixel may be adapted to be joined with other EL elements or nixels to form a pixel, a subpixel or a plurality of pixels or subpixels for an ELD. The EL element or nixel of the present invention can be formed in a variety of shapes and sizes to suit a variety of ELD applications. Because each EL element or nixel may be manufactured separately, each EL element or nixel can be processed according to its own manufacturing requirements. For example, an EL element or nixel that includes a first type phosphor may be processed at a different temperature than an EL element or nixel that includes a second type phosphor. In addition, each EL element or nixel can be individually tested and sorted according to its mechanical, optical, electrical, or other characteristics. Placement of an EL element or nixel relative to other ELD elements or nixels can thus be controlled to meet desired user specifications and to optimize ELD performance.

Embodiments of the present invention can be used to produce EL elements or nixels in a variety of shapes and sizes. As mentioned previously, the mechanical attributes of the EL elements or nixels can be influential factors affecting the types of ELDs in which they are incorporated as well as the methods by which they are combined to form an ELD. The EL elements or nixels can be variably sized and shaped by using die cutting, punching, or other techniques to form a desired EL element or nixel shape.

According to an embodiment of the invention, there is an electroluminescent (EL) display element. The EL display element may include a dielectric layer having an upper surface and a lower surface, and a top conductive layer having an upper surface and a lower surface, where the top conductive layer and the dielectric layer are positioned opposite one another so that the lower surface of the top conductive layer faces the upper surface of the dielectric layer. The display element also includes a phosphor layer, where the phosphor layer is arranged between the dielectric layer and the top conductive layer, and a bottom conductive layer having an upper surface and a lower surface, where the bottom conductive layer and the dielectric layer are positioned opposite one another so that the upper surface of the bottom conductive layer faces the lower surface of the dielectric layer, and where the bottom conductive layer forms a first bottom electrode and a second bottom electrode.

According to another embodiment of the invention, there is an electroluminescent (EL) display element. The EL display element includes a dielectric layer having an upper surface and a lower surface, and a top conductive layer having an upper surface and a lower surface, where the top conductive layer and the dielectric layer are positioned opposite one another so that the lower surface of the top conductive layer faces the upper surface of the dielectric layer and where the top conductive layer forms a first top electrode and a second top electrode. The EL display element also includes a phosphor layer, where the phosphor layer is arranged between the dielectric layer and the top conductive layer, and a bottom conductive layer having an upper surface and a lower surface, where the bottom conductive layer and the dielectric layer are positioned opposite one another so that the upper surface of the bottom conductive layer faces the lower surface of the dielectric layer, and where the bottom conductive layer is patterned to form a first bottom electrode, a second bottom electrode, and a third bottom electrode.

According to yet another embodiment of the invention, there is a method for fabricating an electroluminescent (EL) display element. The method includes providing a dielectric layer having an upper surface and a lower surface, depositing a phosphor layer over the upper surface of the dielectric layer, and arranging a top conductive layer such that the top conductive layer and the dielectric layer sandwich the phosphor layer. The method further includes arranging a bottom conductive layer such that the bottom conductive layer and the phosphor layer sandwich the dielectric layer, where the bottom conductive layer forms a first bottom electrode and a second bottom electrode.

Accordingly, embodiments of the invention can be used to produce variously shaped and sized EL elements or nixels that can be combined to form an ELD with each electroluminescent element or nixel having both electrical contacts (e.g., electrodes) on one side of the electroluminescent element. The EL elements or nixels can be selectively arranged to make an ELD in which ELD performance can be optimized for a particular application.

### BRIEF DESCRIPTION OF THE DRAWINGS

The invention will be more fully understood from the following detailed description thereof taken in connection with the accompanying drawings, which form part of this application, and in which:

FIG. 1A illustrates a perspective view of an EL chip with two back electrical contacts, according to an exemplary embodiment of the invention.

FIG. 1B shows a rear view of the EL chip of FIG. 1A, according to an exemplary embodiment of the invention;

FIG. 1C illustrates a perspective view of another EL chip having a sphere-supported thin film phosphor electroluminescent device with two single-sided contacts, according to an exemplary embodiment of the invention.

FIG. 2A shows a bottom view of an EL chip, according to an exemplary embodiment of the invention;

FIG. 2B shows a bottom view of an EL chip, according to an exemplary embodiment of the invention.

FIG. 3 shows a cross section of an EL chip, according to an exemplary embodiment of the invention.

FIG. 4 shows a pattern of pixels constructed using the EL chips of FIG. 2A, according to an exemplary embodiment of the invention.

FIG. 5 shows illustrative luminescence measurements in accordance with an exemplary embodiment of the invention; and

FIG. 6 shows another exemplary embodiment of a back-contacted nixel.

### DETAILED DESCRIPTION OF EXEMPLARY EMBODIMENTS

In general, the systems, methods, and apparatuses presented herein are directed to an individually formed, modular electroluminescent (EL) element or chip. According to an embodiment of the invention, these EL elements may be “nixels” as illustratively described herein, which are individually sized and modular shaped EL elements that are adapted to form part of an integrated ELD having multiple electrical contacts on the same side of the EL element structure. Alternatively, the EL elements may be sphere-supported thin film phosphor electroluminescent (SSTFEL) devices, as described in WO 2005/024951 A1, published Mar. 17, 2005, and entitled “Sphere-Supported Thin Film Phosphor Electroluminescent Devices,” which is hereby incorporated by reference as if fully set forth herein. While the systems, methods, and apparatuses below for single-sided electrical contacts may be disclosed in the context of nixels, they are for illustrative purposes only. Indeed, it will be appreciated that these systems, methods, and apparatuses for single-sided electrical contacts may also apply to SSTFEL devices or other EL elements as well.

As used herein, the term “module” may refer to a self-contained component of a system, which has a well-defined interface to the other components. Typically something is modular if it includes or uses modules which can be interchanged as units without disassembly of the module. Design, manufacture, repair, etc. of the modules may be complex, but this is not relevant; once the module exists, it can easily be connected to or disconnected from the system.

As required, specific embodiments of the invention are disclosed herein. It should be understood, however, that these are merely exemplary embodiments of the invention that can be variably practiced. Drawings are included to assist the teaching of the invention to one skilled in the art; however, they are not drawn to scale and may include features that are either exaggerated or minimized to better illustrate particular elements of the invention. Related elements may be omitted to better emphasize the novel aspects of the invention. Specific structural and functional details disclosed herein are not to be interpreted as limiting, but merely as a basis for the claims and as a representative basis for teaching one skilled in the art to variously employ embodiments of the invention.

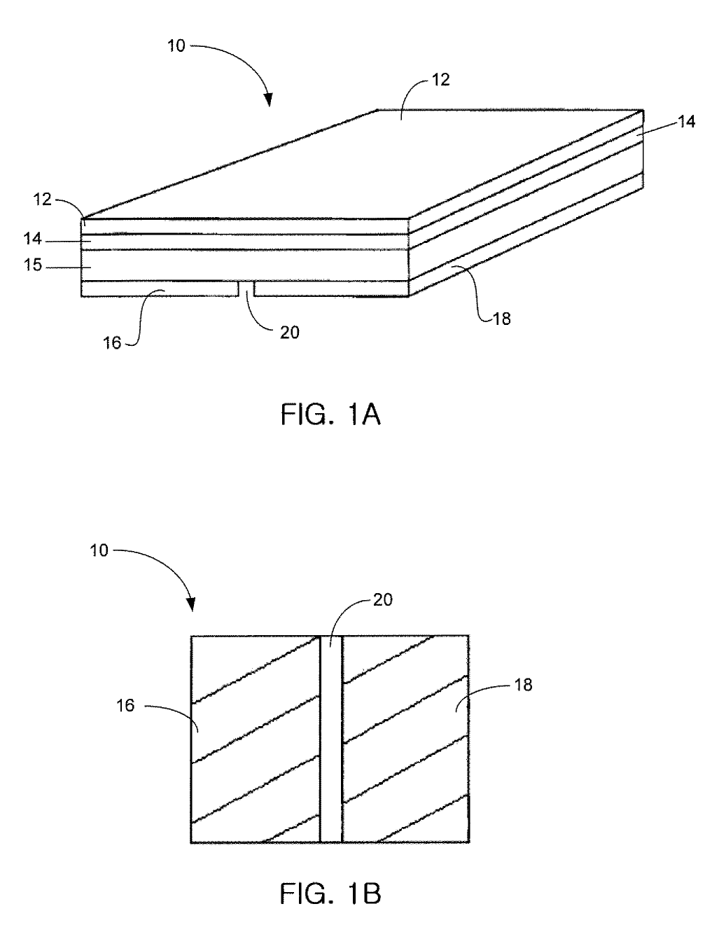

According to an exemplary embodiment of the invention, FIG. 1A illustrates a perspective view of a modular EL chip 10 (e.g., an EL element or nixel chip) with two single-sided electrical contacts (e.g., electrodes) while FIG. 1B illustrates a review view of the EL chip 10 of FIG. 1B. More specifically, the EL chip 10 includes an EL phosphor layer 14 deposited on a dielectric layer 15. A top conductive layer 12 and the two bottom electrode layers 16, 18 sandwich the EL phosphor layer 14 and the dielectric layer 15. The two bottom electrode layers 16, 18 may be electrically separated from each other by a gap 20 or other non-conductive material. While not illustrated, a charge injection layer may be provided between the EL phosphor layer 14 and the dielectric layer 15, or between the EL phosphor layer 14 and the top conductive layer 12. According to an embodiment, the charge injection layer may be an alumina layer. Furthermore, while also not illustrated, transparent stiffeners could also be bonded to the front (e.g., to the top conductive layer 12) of the EL chip 10. Likewise, while also not illustrated, the EL chip 10 may be front-supported (e.g., at top conductive layer 12) by a substantially transparent substrate, such as a clear plastic, polymer, or glass.

Still referring to FIGS. 1A and 1B, it will be appreciated that the top conductive layer 12, which may be an EL emissive layer, may be a transparent conductive material such as indium tin oxide (ITO). However, other flexible, transparent conductive materials may be utilized for the top conductive layer 12, including PEDOT (Poly(3,4-ethylenedioxythiophene), such as H.C. Starck's Baytron®), inherently conductive polymers (ICP), substantially transparent organic or inorganic films, or substantially transparent nano-structure-based (e.g., carbon nanotube, silver nanofiber) conductive films. Similarly, the two bottom electrode layers 16, 18 may comprise any of the conductive materials above, or yet other conductive materials, including gold, silver, aluminum, nickel, copper, chromium, steel, platinum, alloys, a combination thereof and the like.

According to an embodiment of the invention, the dielectric layer 15 may be a ceramic dielectric layer. The ceramic dielectric layer 15 may be composed of barium titanate, BaTiO₃ (BT) or barium strontium titanate, Ba_{0.5}Sr_{0.5}TiO₃ (BST). It will be appreciated that other materials may be used for the dielectric layer 15, including glass, metal oxides, or other dielectric material. The EL phosphor layer 14 may include metal oxide phosphors and sulfide phosphors. Such metal oxide phosphors and methods of production are described in U.S. Pat. Nos. 5,725,801; 5,897,812; 5,788,882 and U.S. patent application Ser. No. 10/552,452, which patents and application are herein incorporated by reference. Metal oxide phosphors include: Zn₂Si_{0.5}Ge_{0.5}O₄:Mn, Zn₂SiO₄:Mn, Ga₂O₃:Eu and CaAl₂O₄:Eu. Sulfide phosphors include: SrS:Cu, ZnS:Mn, BaAl₂S₄:Eu, and BaAl₄S₇:Eu. Where sulfide phosphors are utilized for the EL phosphor layer 14, the sulfide phosphors may be sealed on the front and the sides of the EL chip 10. The sealing layer may vary in thickness according to an embodiment of the invention. Indeed, the sealing layer may be a thin glass coating, according to an embodiment of the invention.

It will be appreciated that alternatives to the EL chip 10 are available without departing from embodiments of the invention. For example, according to another embodiment of the invention, FIG. 1C illustrates another modular EL chip 10 comprising a sphere-supported thin film phosphor electroluminescent device with two single-sided contacts (e.g., electrodes). More particularly, the EL chip 10 of FIG. 1C includes a spherical-shaped dielectric layer 15. A phosphor layer 14 may be deposited on an upper portion of the spherical-shaped dielectric layer 15 to form a hemispherical-shaped phosphor layer, according to an embodiment of the invention. A top conductive layer 12, which likewise may be hemispherical-shaped, may then be provided above an upper surface of the phosphor layer 14. The bottom electrode layers 16, 18 are then provided, perhaps according to a hemispherical shape, on a lower portion of the spherical dielectric layer 15, as illustrated in FIG. 1C.

During operation of the EL chip 10, as illustrated in FIGS. 1A-1B and alternatively in FIG. 1C, the EL chip 10 will be electrically connected to a row voltage and a column voltage using bottom electrode layers 16 and 18. For example, bottom electrode layer 16 may be connected to a row voltage while bottom electrode layer 18 may be connected to a column voltage, according to an embodiment of the invention. Because the row voltage and column voltage connections to the bottom electrode layers 16 and 18 may need to be routed over each other, the row and column connections may be provided as crossovers on a flexible circuit material supporting the EL chip 10. It will be appreciated that the flexible circuit material may be a 2-sided Kapton board with row connections on a first side of the board and column connections on a second side opposite the first side. Vias may be utilized to connect one of the bottom electrode layers 16 and 18 to the row connection or the column connection provided on the Kapton board. In addition, solder bumps, solder paste, conductive epoxy, or other conductive adhesive may be utilized to connect the bottom electrode layers 16 and 18 to the row connection or the column connection provided by the Kapton board. Furthermore, it will also be appreciated that stiffeners, perhaps metal stiffeners, may be applied to a back side of the Kapton board without departing from embodiments of the invention.

According to a first embodiment of the invention, the EL chip 10 may be operated in a push-pull configuration. With a push-pull configuration, equal and opposite voltages may be applied to the bottom electrode layers 16 and 18, to provide a virtual ground (e.g., a substantially zero potential) at the conductive layer 12. According to a second embodiment of the invention, the EL chip 10 may be operated as if at least two discrete EL devices were connected in series so that the voltage across conductive layer 12 may be shared between two EL devices. In this second embodiment, the row voltages applied to the bottom electrode layer 16 may be driven at twice the typical row voltage (e.g., 160V up to 320V) used for discrete EL devices with top and bottom electrodes, but at half the current. By applying twice the typical row voltages to the bottom electrode layer 16, the EL chip 10 capacitance may be about four (4) times smaller than for discrete EL devices with top and bottom electrodes since with both electrodes on a single side, the EL chip 10 includes essentially two half-size discrete EL devices in series. The lowered capacitance may enable an increase in the refresh rate by a factor of four (4), as refresh rates may be fundamentally limited by high EL panel capacitance. Furthermore, this increased refresh rate may decrease the required column or modulation voltages applied to the bottom electrode layer 18 by a factor of two (2). In particular, by increasing the refresh rate by a factor of 4, the modulation voltages normally decrease by a factor of 4. However, because the series connection of essentially two half-size discrete EL devices doubles the drive voltage applied to bottom electrode layer 16, there may be a net decrease in modulation voltage applied to bottom electrode layer 18 by a factor of 2.

As indicated above, the row voltages applied to bottom electrode layer 16 are doubled since the row voltages are normally set according to the threshold voltage of the EL element or nixel. If the row voltages need to be reduced, the thickness of the phosphor layer 14 may be reduced. However, there the higher row voltages may not problematic for several reasons. For example, there are only 1080 rows versus 5760 columns in a single scan full HD display, and only 540 rows versus 11,520 columns in a dual scan HD display. Further, a reduction in column voltages applied to bottom electrode layer 18 may compensate for higher row voltages applied to bottom electrode layer 16. Row driver voltage requirements may be reduced by floating the row drivers, which is commonly used in plasma displays. Furthermore, increasing refresh rate makes grayscale easier to implement and further provides more control over pixel refresh rates.

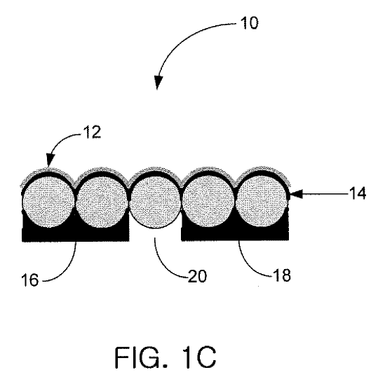

FIGS. 2A and 2B illustrate alternative shapes and configurations of the single-sided electrode layers provided for an EL chip. Generally, FIGS. 2A and 2B illustrate outer and inner electrode rings, where the outer and inner rings are substantially concentric. More specifically, FIG. 2A illustrates a bottom view of a hexagonally shaped EL chip 30. The EL chip 30 includes a gap 32, or other non-conductive material, that electrically separates a column electrode layer 34 from a row electrode layer 36. Likewise, FIG. 2B is similar to FIG. 2A, except that the EL chip 40 is circularly shaped instead of hexagonally shaped. In particular, FIG. 2B illustrates a bottom view of a circularly shaped EL chip 40. The EL chip 40 includes a gap 42, or other non-conductive material, that electrically separates the column electrode layer 44 and the row electrode layer 46. It will be appreciated that while gaps 32 and 42 are illustrated as circular in FIGS. 2A and 2B, respectively, they may be provided in a variety of shapes without departing from embodiments of the invention, including squares, rectangles, and other polygonal shapes. It will also be appreciate that according to some embodiments of the invention, the positions of the row electrode layers and column electrode layers may be reversed without departing from embodiments of the invention.

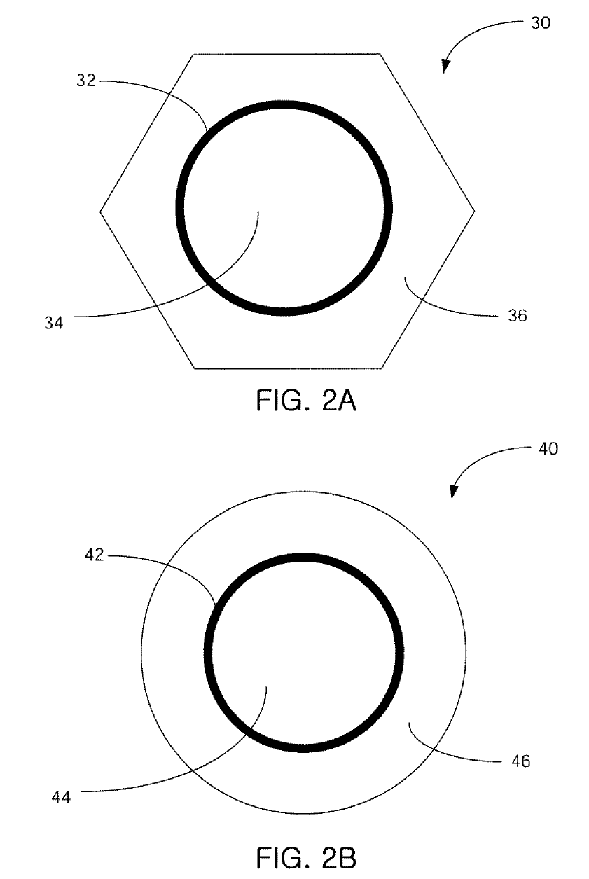

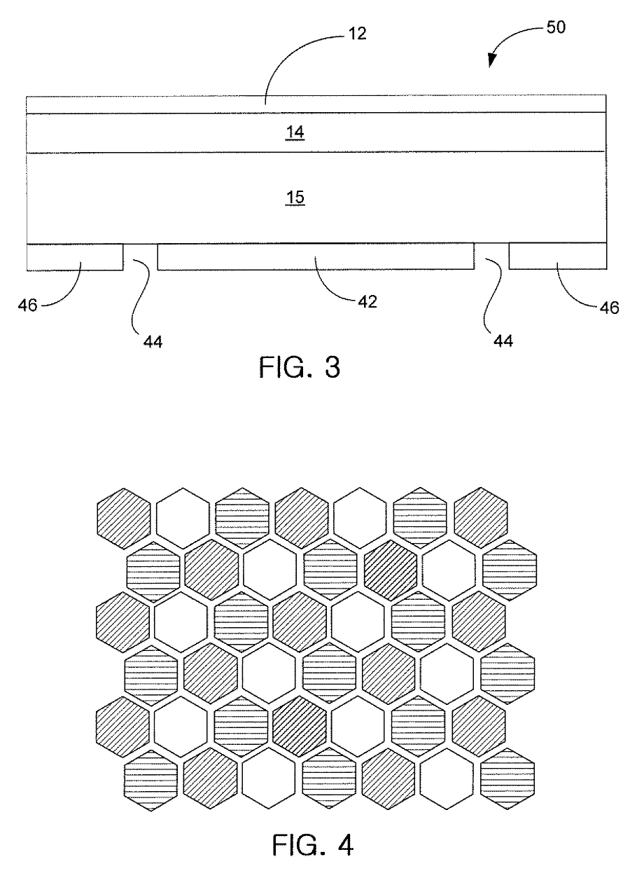

FIG. 3 illustrates an exemplary cross-sectional view of an EL chip 50 that includes the single-sided electrodes of FIG. 2A or 2B above. Like the EL chip 10 of FIG. 1A, the EL chip 50 of FIG. 4 may include a conductive layer 12, an EL phosphor layer 14, and a dielectric layer 15. The other side of the dielectric layer 15 may include a gap 44, or other non-conductive material, that electrically separates the row electrode layer 46 from the column electrode layer 42. According to an embodiment of the invention, the column electrode layer 42 may be centrally located on bottom of the EL chip 50.

FIG. 4 shows a configuration of pixels (e.g., with red, green, and blue pixels) constructed using the EL chips 30 of FIG. 2A. It will be appreciated that while the configuration of FIG. 4 uses hexagonally shaped EL chips 30, other shapes of EL chips may be utilized as well, including square, rectangular, and round EL chips, which include at least two electrodes located on the a single side of the dielectric layer 15. Indeed, EL displays may be produced using any one shape, or any combination of these shapes and they may be of the same or different sizes without departing from embodiments of the invention.

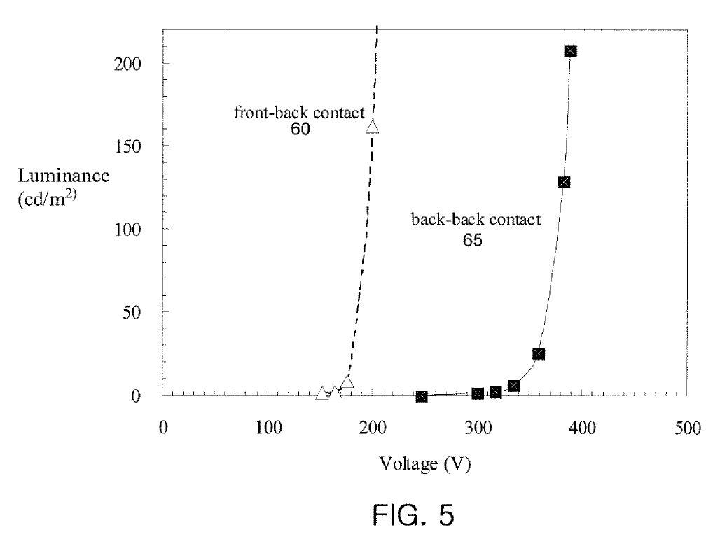

FIG. 5 illustrates exemplary EL (e.g., element or nixel) chip luminescence results obtained with using the EL chip 10 of FIG. 1, according to an embodiment of the invention. If the applied voltage is connected across the conductive layer 12 and the electrical contact 16, the front-back contact brightness curve 60 is obtained. On the other hand, if the applied voltage is connected across electrical contacts 16 and 18, the back-back contact curve 65 is obtained. By comparing curves 60 and 65, it will be appreciated that the effect of using two single-sided (e.g., two back) electrical contacts is to generally double the applied voltage for a given brightness value.

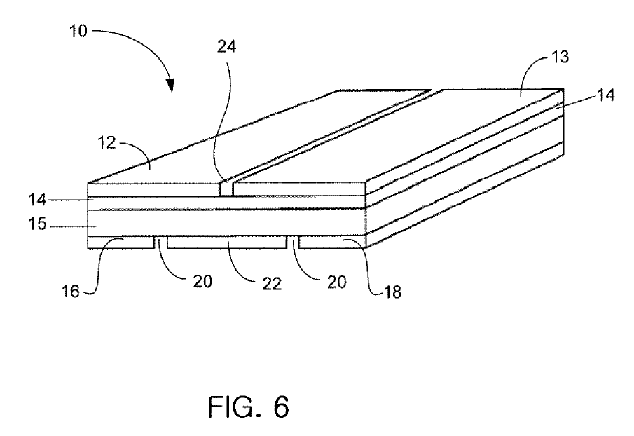

FIG. 6 shows another embodiment of a single-sided contact EL chip 10, which includes an equivalent of essentially four (4) discrete EL devices connected in series. In particular, EL chip 10 includes two top conductive layers 12 and 13 that are separated by a gap 24 or other non-conductive material. EL phosphor layer 14 and dielectric layer 15 have been described previously, and the discussion will not be repeated here. The single-sided electrodes include three non-continuous electrode layers 16, 18, and 22, which are each electrically separated from each other by a gap 20 or another non-conductive material. According to an embodiment of the invention, the row voltages can be applied to electrode layer 16 while the column voltages can be applied to electrode layer 18. In this configuration, the two top conductive layers 12 and 13 and electrode layer 22 function as bridging electrodes to ensure that the voltages applied to electrode layers 16 and 18 are divided across essentially 4 discrete EL devices connected in series. For example, when voltage is applied across electrode layers 16 and 18, it falls across a first EL element between electrode layer 16 and top conductive layer 12, a second EL element between layers 12 and 22, a third EL element between layers 22 and 13, and a fourth EL element between layer 13 and electrode layer 18. It will be appreciated that the total applied row voltage may now be four (4) times higher than the row voltage provided for a discrete EL device with top and bottom electrodes. Further, the increase in voltage will decrease the EL chip 10 capacitance by a factor of 16, potentially enabling a 16 times higher refresh rate. It will be appreciated that by similar patterning of top conductive layer and the bottom single-sided electrodes, the equivalent of more than 4 discrete EL devices may be connected in series.

Therefore, the modular EL chips with the electrical contacts (e.g., electrodes) formed on one side thereof may be assembled into an electroluminescent matrix-addressed display comprising a plurality of electroluminescent pixels arranged in a 2-dimensional array, each pixel being electrically connected across a unique combination of one of conductive row electrodes and one of conductive column electrodes, with the row connected to the first rear electrode of the electroluminescent pixel and the column connected to the second rear electrode of the electroluminescent pixel. Thus, embodiments of the invention provide a discrete electroluminescent display module, an EL element or nixel, having both electrical contacts on the same side thereof, that can be individually manufactured, tested, sorted and selectively positioned to make an ELD in accordance with the invention.

The methods of the invention can produce a flexible display with scalable dimensions that avoids the limitations imposed by prior art processes that employ glass to provide structure. Exemplary embodiments are included herein as examples of an invention that can be variably implemented and practiced, and as such, are not considered to be limitations, since modifications and alternative embodiments will be apparent to those skilled in the art. Thus, the invention encompasses all the embodiments and their equivalents that fall within the scope of the appended claims.

What is claimed is:

1. An electroluminescent display element, comprising:
a dielectric layer having an upper surface and a lower surface;
a top conductive layer having an upper surface and a lower surface, wherein the top conductive layer and the dielectric layer are positioned opposite one another so that the lower surface of the top conductive layer faces the upper surface of the dielectric layer;
a phosphor layer, wherein the phosphor layer is arranged between the dielectric layer and the top conductive layer; and
a bottom conductive layer having an upper surface and a lower surface, wherein the bottom conductive layer and the dielectric layer are positioned opposite one another so that the upper surface of the bottom conductive layer faces the lower surface of the dielectric layer, and wherein the bottom conductive layer forms a first bottom electrode and a second bottom electrode.

2. The electroluminescent display element of claim 1, wherein the dielectric layer, the top conductive layer, the phosphor layer, and the bottom conductive layer are each one of (i) substantially planar, (ii) substantially spherical, and (iii) substantially hemispherical.

3. The electroluminescent display element of claim 1, further comprising a charge injection layer arranged between at least one of (i) the phosphor layer and the dielectric layer, and (ii) the phosphor layer and the top conductive layer.

4. The electroluminescent display element of claim 1, wherein the first bottom electrode and the second bottom electrode are electrically separated from each other by one of (i) a gap, and (ii) a non-conductive material.

5. The electroluminescent display element of claim 1, wherein the first bottom electrode is substantially the same size as the second bottom electrode.

6. The electroluminescent display element of claim 1, wherein the first and second electrodes are substantially parallel to each other.

7. The electroluminescent display element of claim 1, wherein the first electrode comprises an outer ring and the second electrode comprises an inner ring, wherein the outer and inner rings are substantially concentric.

8. The electroluminescent display element of claim 7, wherein one or both of the outer and inner rings are shaped as (i) a circle, (ii) a hexagon, (iii) a square, and (iv) a rectangle.

9. The electroluminescent display element of claim 1, wherein the first and second bottom electrodes are electrically connected to voltage connections.

10. The electroluminescent display element of claim 9, wherein the first bottom electrode is electrically connected to a row voltage connection and the second bottom electrode is electrically connected to a column voltage connection.

11. The electroluminescent display element of claim 10, further comprising at least one via electrically connecting one of the first bottom electrode and the second bottom electrode to the respective row voltage connection or column voltage connection.

12. The electroluminescent display element of claim 11 further comprising a flexible substrate having the row voltage connection and the column voltage connection formed on opposite sides thereof, wherein the at least one via is provided through the flexible substrate to electrically connect with the respective row voltage connection or the column voltage connection.

13. The electroluminescent display element of claim 12, wherein the top conductive layer overlaps with at least a portion of the first and second bottom electrodes in a substantially vertical plane.

14. The electroluminescent display element of claim 13, wherein the portion of the phosphor layer sandwiched between the overlapping first and second electrodes is operable to emit electroluminescence.

15. The electroluminescent display element of claim 1, wherein the top conductive layer is substantially transparent.

16. The electroluminescent display element of claim 1, wherein the top conductive layer comprises at least one of (i) (Poly(3,4-ethylenedioxythiophene) (PEDOT), (ii) Indium Tin Oxide (ITO), (iii) inherently conductive polymer (ICP), (iv) a substantially transparent conductive organic or inorganic film, and (v) a substantially transparent nano-structure-based conductive film.

17. The electroluminescent display element of claim 1, wherein the upper surface of the top conductive layer is supported on a substantially transparent substrate.

18. The electroluminescent display element of claim 1, wherein the substantially transparent substrate is at least one of a plastic, a polymer, and glass.

19. An electroluminescent display element, comprising:
a dielectric layer having an upper surface and a lower surface;
a top conductive layer having an upper surface and a lower surface, wherein the top conductive layer and the dielectric layer are positioned opposite one another so that the lower surface of the top conductive layer faces the upper surface of the dielectric layer, wherein the top conductive layer forms a first top electrode and a second top electrode;
a phosphor layer, wherein the phosphor layer is arranged between the dielectric layer and the top conductive layer; and
a bottom conductive layer having an upper surface and a lower surface, wherein the bottom conductive layer and the dielectric layer are positioned opposite one another so that the upper surface of the bottom conductive layer faces the lower surface of the dielectric layer, and wherein the bottom conductive layer is patterned to form a first bottom electrode, a second bottom electrode, and a third bottom electrode.

20. The electroluminescent display element of claim 19, wherein the dielectric layer, the top conductive layer, the phosphor layer, and the bottom conductive layer are each one of (i) substantially planar, (ii) substantially spherical, and (iii) substantially hemispherical.

21. The electroluminescent display element of claim 19, wherein the first top electrode and the second top electrode are separated from each other by one of (i) a gap, and (ii) a non-conductive material, and wherein the first bottom electrode, the second bottom electrode, and the third bottom electrode are electrically separated from each other by one of (i) a gap, and (ii) a non-conductive material.

22. The electroluminescent display element of claim 19, wherein the second bottom electrode is arranged between the first bottom electrode and the third bottom electrode.

23. The electroluminescent display element of claim 22, wherein the second bottom electrode overlaps a portion of both the first top electrode and the second top electrode in a substantially vertical plane.

24. The electroluminescent display element of claim 23, wherein the first bottom electrode overlaps a portion of the first top electrode, but not the second top electrode, in a first substantially vertical plane, and wherein the third bottom electrode overlaps a portion of the second top electrode, but not the first top electrode, in a second substantially vertical plane.

25. The electroluminescent display element of claim 19, wherein the first and third bottom electrode layers are electrically connected voltage connections.

26. The electroluminescent display element of claim 25, wherein the first bottom electrode is electrically connected to a column voltage connection and the third bottom electrode is electrically connected to a row voltage connection.

27. The electroluminescent display element of claim 19, wherein the top conductive layer comprising the first and second top electrodes is substantially transparent.

28. The electroluminescent display element of claim 27, wherein the top conductive layer comprises at least one of (i) (Poly(3,4-ethylenedioxythiophene) (PEDOT), (ii) ITO, (iii) inherently conductive polymers (ICP), (iv) substantially transparent organic or inorganic films, and (v) substantially transparent nano-structure-based conductive films.

29. A method for fabricating an electroluminescent display element, comprising:
providing a dielectric layer having an upper surface and a lower surface;
depositing a phosphor layer over the upper surface of the dielectric layer;
arranging a top conductive layer such that the top conductive layer and the dielectric layer sandwich the phosphor layer; and
arranging a bottom conductive layer such that the bottom conductive layer and the phosphor layer sandwich the dielectric layer, wherein the bottom conductive layer forms a first bottom electrode and a second bottom electrode.

30. The method of claim 29, wherein the dielectric layer, the top conductive layer, the phosphor layer, and the bottom conductive layer are each one of (i) substantially planar, (ii) substantially spherical, and (iii) substantially hemispherical.

31. The method of claim 29, further comprising providing a charge injection layer arranged between at least one of (i) the phosphor layer and the dielectric layer, and (ii) the phosphor layer and the top conductive layer.

32. The method of claim 29, wherein the first bottom electrode and the second bottom electrode are electrically separated from each other by one of (i) a gap, and (ii) a non-conductive material.

33. The method of claim 29, wherein the first electrode comprises an outer ring and the second electrode comprises an inner ring, wherein the outer and inner rings are substantially concentric.

34. The method of claim 33, wherein one or both of the outer and inner rings are shaped as (i) a circle, (ii) a hexagon, (iii) a square, and (iv) a rectangle.

35. The method of claim 29, wherein the first and second bottom electrodes are electrically connected to voltage connections.

36. The method of claim 29, wherein the top conductive layer overlaps with at least a portion of the first and second bottom electrodes in a substantially vertical plane.

37. The method of claim 36, wherein the portion of the phosphor layer sandwiched between the overlapping first and second electrodes is operable to emit electroluminescence.

38. The method of claim 29, wherein the top conductive layer is substantially transparent.

39. The method of claim 29, wherein the top conductive layer comprises at least one of (i) (Poly(3,4-ethylenedioxythiophene) (PEDOT), (ii) Indium Tin Oxide (ITO), (iii) inherently conductive polymer (ICP), (iv) a substantially transparent organic or inorganic film, and (v) a substantially transparent nano-structure-based conductive film.

40. The method of claim 29 in which the upper surface of the top electrode is supported on a substantially transparent substrate.

41. The method of claim 29 wherein the substantially transparent substrate is at least one of a plastic, a polymer, and glass.
